(19) United States
(12) Patent Application Publication
(10) Pub. No.: US 2014/0273987 A1
(43) Pub. Date: Sep. 18, 2014

(54) Challenge Response System to Detect Automated Communications

(71) Applicant: Google Inc., Mountain View, CA (US)

(72) Inventor: Thomas Price, San Francisco, CA (US)

(21) Appl. No.: 13/803,460

(22) Filed: Mar. 14, 2013

(51) Int. Cl. H04W 12/12

(52) U.S. Cl. CPC H04W 12/12
USPC 455/414.1

(57) ABSTRACT

Systems and methods associated with providing a challenge response test on a client device are provided. The systems and methods include receiving at the client device, a communication initiated at the sender device. The client device determines whether the communication should be challenged. The client device transmits a challenge to the sender device. The client device receives a response to the challenge indicative of whether the incoming communication from the sender device is from a safe sender. The response is analyzed to determine whether the incoming communication is from a safe sender.

### BACKGROUND OF THE INVENTION

As voice over internet protocol (VOIP) dialing systems and internet protocol (IP) based text messaging systems become common, it has become easier for spammers to send large number of robo-calls and text messages. Since mobile phones are with users throughout the day, it is important to prevent unwanted calls from interrupting a user's daily activities. Mobile phones receive communications from numerous sources including voice calls, SMS messages, MMS messages, email, instant messages and VOIP calls. Spammers are able to reach mobile phone users through numerous communication methods.

Phone spam systems are typically limited to all-or-nothing blocking services that prevent communications from any unknown number from reaching the recipient. Phone systems are unable to selectively block communications based on intelligent screening of the messages.

### BRIEF SUMMARY OF THE INVENTION

One embodiment provides a method for detecting spam telephone calls initiated at a caller device and made to a client device. The method includes receiving at the client device a telephone call from the caller device. The client device determines whether the telephone call should be challenged. The client device automatically answers the call and prompts the user of the caller device to touch-tone a code into the caller device. The client device then determines whether a response to the prompt matches the code. Finally, the telephone call is connected.

Another embodiment provides a method of detecting spam communications from a sender device to a client device. The method includes receiving at the client device, a communication initiated at the sender device. The client device determines whether the communication should be challenged. The communication is stored in a holding queue at the client device. The client device transmits a challenge to the sender device. The client device receives a response to the challenge indicative of whether the incoming communication from the sender device is from a safe sender. The response is analyzed to determine whether the incoming communication is from a safe sender. The communication is then released from the holding queue.

An alternative embodiment provides a computer-readable storage medium storing instructions that, when executed by a processor, cause a computer system to detect spam communications from a sender device to a client device. The instructions cause the client device to receive a communication initiated at the sender device. The instructions cause the client device to determine whether the communication should be challenged. The instructions cause the communication to be stored in a holding queue at the client device. The client device transmits a challenge to the sender device based on the instructions. The instructions cause the client device to accept a response to the challenge indicative of whether the incoming communication from the sender device is from a safe sender. The response is analyzed to determine whether the incoming communication is from a safe sender based on the instructions and the communication is then released from the holding queue.

### BRIEF DESCRIPTION OF THE SEVERAL VIEWS OF THE DRAWING(S)

FIG. 1 is a block diagram of an exemplary system for implementing a challenge response spam filter according to one example embodiment.

FIG. 2 is a block diagram of the arrangement of components of a client device configured to implement a challenge response spam filter according to an example embodiment.

FIG. 3 is a block diagram of exemplary functional components for a client device according to an example embodiment.

FIG. 4 is a flow diagram for a challenge response spam filter according to an example embodiment.

FIG. 5 is a flow diagram for a challenge response spam filter for short message service messages according to an example embodiment.

FIG. 6 is a flow diagram for a challenge response spam filter for multimedia messaging service message according to an example embodiment.

FIG. 7 is a flow diagram for a challenge response spam filter for telephone calls according to an example embodiment.

### DETAILED DESCRIPTION OF THE INVENTION

Some embodiments of the disclosure provide for a challenge response filter for unwanted, automated or spam communications (“spam”). One exemplary type of challenge response filter is a completely automated public Turing test to tell computers and humans apart (“CAPTCHA”). Exemplary communications that can be filtered include telephone calls, short messaging service (“SMS”) messages and multimedia messages (“MMS”). Additional communications can also be filtered, such as electronic mail and instant messages.

According to embodiments of the disclosure, a hardware component or a software application on a mobile device, such as a cellular telephone, apply the challenge response filter to incoming communications when the communication is from an unknown sender or transmission device. For example, in one embodiment if a client device receives an SMS message associated with an unknown sender telephone number, the client device applies an appropriate challenge response test. The client device may automatically place the SMS message in a holding queue and call the number associated with the SMS message. If the telephone call is answered, the client device performs a challenge response test by automatically providing an audible code and requesting that the user of the sender telephone touch-tone the code into their phone. The client device verifies the code was properly entered and then releases the SMS message from the holding queue. The message is then handled, as it typically would be by the client device, by for example, going to an inbox for SMS messages. This and additional embodiments will be further explained below with reference to the figures.

The challenge response test may be implemented in software on the client device. In one embodiment, the challenge response test functionality is incorporated into an operating system running on the client device. In an alternative embodiment, the challenge response test functionality is a separate program running on the client device.

FIG. 1 is a block diagram of an exemplary system for implementing a challenge response spam filter according to one example embodiment. The system includes a client device 102, a data network 104, a network device 106 and in some embodiments a challenge-response server 108.

The client device 102 can be any type of computing device, including a personal computer, laptop computer, tablet computer, mobile phone with computing capabilities, or any other type of device. The client device 102 is more fully explained below.

The data network 104 can be any type of communications network, including an Internet network (e.g., wide area network (WAN) or local area network (LAN)), wired or wireless network, or mobile phone data or voice network, among others. Additionally, network 104 may be a combination of protocols such as mobile phone data and voice networks.

The network device 106 is configured to communicate with other devices on the network, such as client device 102. Network device 106 can be any type of computing device, including a personal computer, laptop computer, tablet computer, mobile phone with computing capabilities, or any other type of device. In some embodiments client device 102 and network device 106 are the same type of device. For example, both devices could be a mobile telephone.

In some embodiments, the challenge-response server 108 may administer the challenge response test. For example, if the client device 102 receives a MMS message from the network device 106 over the network 104, the client device 102 may send a message to the challenge response server 108 over the network 104. In response to the message, the challenge response server 108 could then transmit a challenge response test, such as a CAPTCHA image to network device 106. If network device 106 correctly responds to the challenge response test, the challenge response server 108 will then send a message to client device 102 confirming that the network device 106 correctly responded to the test.

FIG. 2 is a block diagram of the arrangement of components of a client device configured to implement a challenge response spam filter according to an example embodiment. As shown, client device 102 includes a processor 202, memory 204 and device hardware 206

The memory 204 includes various applications that are executed by processor 202, including installed applications 210 and an operating system 208. For example, installed applications 210 may be downloaded and installed from an applications store or other source. Applications 210 may also come installed on client device 210.

Device hardware 206 includes hardware components for the client device 102. Exemplary hardware includes a network interface for communicating over network 104. The network interface may include, for example, cellular radios and interfaces, WiFi® radios and interfaces or Ethernet interfaces. A display 214 may be included to provide a user interface for displaying applications, data and communications, such as SMS messages. The display may provide a virtual keyboard. Additional hardware devices such as GPS, a keyboard, accelerometers, a compass, a light sensor and others may be included.

FIG. 3 is a block diagram of exemplary functional components for a client device according to an example embodiment. One particular example of client device 302 is illustrated. Many other embodiments of the client device 302 may be used. In the illustrated embodiment of FIG. 3, the client device 302 includes one or more processor(s) 306, memory 308, a network interface 310, one or more storage devices 312, a power source 314, input output device(s) 318, including for example, a display 320.

The client device 302 also includes an operating system 304 and a communications client 316 that are executable by the client. Each of components 304, 306, 308, 310, 312, 314, 316, 318 and 320 is interconnected physically, communicatively, and/or operatively for inter-component communications in any operative manner.

Software modules 322 more be separate applications saved in memory or storage. Alternatively some or all software modules 322 may be incorporated into the operating system 304. Exemplary software modules 322 include an address book 323 for saving contact information for users, voice component 324 for telephone calls, image test engine 326 for providing visual challenge response tests, such as CAPTCHA images, holding queue 328 for storing challenged communications, MMS component 330 for MMS messaging, Audio test engine 332 for providing audible challenge response tests and SMS component 334 for providing SMS messaging.

As illustrated, processor(s) 306 are configured to implement functionality and/or process instructions for execution within client device 302. For example, processor(s) 306 execute instructions stored in memory 308 or instructions stored on storage devices 312. Memory 308, which may be a non-transient, computer-readable storage medium, is configured to store information within client device 302 during operation. In some embodiments, memory 308 includes a temporary memory, area for information not to be maintained when the client device 302 is turned OFF. Examples of such temporary memory include volatile memories such as random access memories (RAM), dynamic random access memories (DRAM), and static random access memories (SRAM). Memory 308 maintains program instructions for execution by the processor(s) 306.

Storage devices 312 also include one or more non-transient computer-readable storage media. Storage devices 312 are generally configured to store larger amounts of information than memory 308. Storage devices 312 may further be configured for long-term storage of information. In some examples, storage devices 312 include non-volatile storage elements. Non-limiting examples of non-volatile storage elements include magnetic hard disks, optical discs, floppy discs, flash memories, or forms of electrically programmable memories (EPROM) or electrically erasable and programmable (EEPROM) memories.

The client device 302 uses network interface 310 to communicate with external devices via one or more networks, such as server 108 and/or network device 106 shown in FIG. 1. Network interface 310 may be a network interface card, such as an Ethernet card, an optical transceiver, a radio frequency transceiver, or any other type of device that can send and receive information. Other non-limiting examples of network interfaces include wireless network interface, Bluetooth®, 3G and WiFi® radios in mobile computing devices, and USB (Universal Serial Bus). In some embodiments, the client device 302 uses network interface 310 to wirelessly communicate with an external device, a mobile phone of another, or other networked computing device.

The client device 302 includes one or more input/output devices 318. Devices are configured to receive input from a user through tactile, audio, video, or other sensing feedback. Non-limiting examples of input devices include a display 320, a mouse, a keyboard 321, a voice responsive system, camera, a video recorder, a microphone 327, a GPS module, or any other type of device for detecting a command from a user or sensing the environment. In some examples, a presence-sensitive display includes a touch-sensitive display.

One or more output devices are also included in client device 302. Output devices are configured to provide output to a user using tactile, audio, and/or video stimuli. Output devices may include a display 320 (part of the presence-sensitive screen), a sound card, a video graphics adapter card, or any other type of device for converting a signal into an appropriate form understandable to humans or machines. Additional examples of output device include a speaker 325, a cathode ray tube (CRT) monitor, a liquid crystal display (LCD), or any other type of device that can generate intelligible output to a user. In some embodiments, a device may act as both an input device and an output device.

The client device 302 includes one or more power sources 314 to provide power to the client device 302. Non-limiting examples of power source 314 include single-use power sources, rechargeable power sources, and/or power sources developed from nickel-cadmium, lithium-ion, or other suitable material.

The client device 302 includes an operating system 304, such as the Android® operating system. The operating system 304 controls operations of the components of the client device 302. For example, the operating system 304 facilitates the interaction of communications client 316 with processors 306, memory 308, network interface 310, storage device(s) 312, input/output devices 318, and power source 314 Additionally, the operating system 304 controls the operation of software modules 322. Alternatively, certain software modules 322 are part of the operating system 304.

As also illustrated in FIG. 3, the client device 302 includes communications client 316. Communications client 316 includes program instructions and/or data that are executable by the client device 302. For example, in one embodiment, communications client 316 includes instructions causing the communications client 316 executing on the client device 302 to perform one or more of the operations and actions described in the present disclosure, such as transmitting SMS messages, MMS messages, data and/or telephone calls. In some embodiments, communications client 316 forms a part of operating system 304 executing on the client device 302.

FIG. 4 is a flow diagram for a challenge response spam filter according to an example embodiment. Persons skilled in the art will understand that even though the method 400 is described in conjunction with the systems of FIGS. 1-3, any system configured to perform the method stages is within the scope of embodiments of the disclosure.

As shown, the method 400 begins at stage 402, where a communication is received by, for example, client device 102. The communication may be an incoming telephone call, SMS message, MMS message, instant message, electronic mail, VOIP call, or any other type of communication from a sender device. In one embodiment, the communication is sent from network device 106 to the client device 102 through the network 104. At stage 404 the client device determines whether to challenge the communication. In one embodiment, the client device checks to see whether the communication is from a user or device with contact information in the client address book. For example, the client device may check to see if a new SMS message is from a device having a telephone number associated with someone in the client device address book. Similarly, the client device may check telephone call and MMS messages for an entry in the address book. The client device may also use user names or email address for emails, instant messages and other types of information. In some cases, a unique idea associated with the sending device may be used. Other systems such as a Bayesian algorithm or safe senders list can also be used to determine whether to challenge a communication.

If the communication is associated with a known sender, the communication is deemed safe and at stage 416, the client device processes the communication normally. If the communication is not associated with a known sender, the communication is stored in a holding queue at stage 405. For example, MMS messages, SMS messages, email, instant messages, and other communications can be placed in a queue while the sender of the communication is challenged. The queue temporarily holds the communication until it is determined that the sender is safe. In some embodiments, such as receiving a telephone call, the communication may be disconnected during the challenge response test and the call can later be reconnected or as explained below, the call can be automatically answered rather then going into a queue.

At stage 406 the client device transmits a challenge response test to the sender device. The challenge response test may be an image test or audible test. For example, if a telephone call is received, the client device may automatically answer the call and play an audible code. If an SMS message is received, the client device may call the number that sent the SMS and play an audible code. If an MMS is received, the client device may send back via MMS a CAPTCHA image. Similar methods may be used for other communications.

At stage 408 the client receives a response to the challenge. The client device determines at stage 410 whether the response is correct for the challenge response test. If the response is incorrect, the client device may determine that the communication is spam at step 414. In some embodiments, the client device may also send a number of challenge response tests before determining that a communication is spam. If a response is not received after a certain period of time, the client device may determine that the communication is spam.

If the communication is safe, the client device releases the communication from the queue at stage 412 and at stage 416 the safe communication enters the normal device handling for the communication.

FIG. 5 is a flow diagram for a challenge response spam filter for short message service messages according to an exemplary embodiment. Persons skilled in the art will understand that even though the method 500 is described in conjunction with the systems of FIGS. 1-3, any system configured to perform the method stages is within the scope of embodiments of the disclosure.

At stage 502 a client device receives an SMS message from a sender device. Exemplary devices are mobile telephones, but other devices capable of sending and receiving SMS messages such as tablet computers are also contemplated. At stage 504 the client device determines whether the SMS message is from a known sender. As described in conjunction with FIG. 4, methods for determining whether a communication is from a safe sender include checking an address book or safe senders list. If the SMS message is associated with a known sender, the communication is deemed safe and at stage 520, the client device processes the communication normally. If the communication is not associated with a known sender, the communication is stored in a holding queue at stage 506.

At stage 508, the client device transmits an SMS message to the sender device containing a phone number to an audio challenge-response test. The phone number may be associated with the client device or the phone number may connect to a challenge response server 108 (FIG. 1). In another embodiment, the client device may call the sender device directly. At stage 510, a telephone call from the sender device is received and at stage 512 the audio challenge response test is administered. In one embodiment, the client device receives the call, automatically answers it based upon, for example the telephone number, and administers the test by utilizing a service providing an audio challenge-response test. An example service is the audio test engine 332 (FIG. 3). In alternative embodiments, the call is received by a server and the test is administered by the server. The client device may send the server a message notifying it that a test should be administered to the sender device. The audio challenge response test may be a code played audibly over the telephone.

At stage 514, the client device verifies that the code was touch toned into the sender device properly. Alternatively, if the server administers the test, the server verifies the response and sends a message with the results to the client device. If the response is incorrect, the client device may determine that the SMS message is spam at step 518. If no one calls the number sent via SMS, the client device may determine that the communication is spam.

If the SMS message is safe, the client device releases the message from the queue at stage 516 and at stage 520 the safe SMS message enters the normal device handling, such as an SMS message inbox.

FIG. 6 is a flow diagram for a challenge response spam filter for multimedia messaging service message according to an example embodiment. Persons skilled in the art will understand that even though the method 600 is described in conjunction with the systems of FIGS. 1-3, any system configured to perform the method stages is within the scope of embodiments of the disclosure.

At stage 602 a client device receives an MMS message from a sender device. Exemplary devices are mobile telephones, but other devices capable of sending and receiving MMS messages such as tablet computers are also contemplated. At stage 604 the client device determines whether the MMS message is from a known sender. As described in conjunction with FIGS. 4 and 5, methods for determining whether a communication is from a safe sender include checking an address book or safe senders list. If the MMS message is associated with a known sender, the communication is deemed safe and at stage 618, the client device processes the communication normally. If the MMS is not associated with a known sender, the communication is stored in a holding queue at stage 606.

At stage 608 the client device transmits a MMS message containing an image challenge response test, such as a CAPTCHA image. Alternatively, the client device may transmit a message to a challenge response server requesting that it send an MMS message containing an image challenge response test. The client device receives the response at step 610. In one embodiment the response is sent back via SMS or MMS message. In an alternative embodiment, the response may be sent to the challenge response server.

At stage 612, the client device verifies that the response properly decodes the challenge response image. Alternatively, if the server administers the test, the server verifies the response and sends a message with the results to the client device. If the response is incorrect, the client device may determine that the MMS message is spam at step 616. If a response is not received, the client device may determine that the MMS message is spam.

If the MMS message is safe, the client device releases the message from the queue at stage 614 and at stage 618 the safe MMS message enters the normal device handling, such as an MMS message inbox.

FIG. 7 is a flow diagram for a challenge response spam filter for telephone calls according to an example embodiment. At stage 702 the client device, such as a mobile telephone, receives a telephone call from a caller device. The client device, at stage 704, determines whether the call is from a known caller device. Exemplary devices are mobile telephones, VOIP phones, and landline phones. As described in conjunction with FIGS. 4 and 5, methods for determining whether a communication is from a safe sender include checking an address book or safe senders list. If the call is associated with a known contact, the call is deemed safe and at stage 714, the client device processes the communication normally by for example, ringing the client device to indicate an incoming call. If the call is not associated with a known sender, the call is stored in a is automatically answered by the client device at stage 706.

At stage 708, the client device automatically administers an audio challenge response test. In one embodiment a code is played over the phone. At stage 710, the client device verifies that the correct response to the test was entered. If the correct response was not entered, at stage 712 the client device determines that the call was spam. If the correct code was entered, at stage 714 the client device processes the call normally, which may include ringing or vibrating the client device to indicate an incoming call.

In some embodiments, users may have privacy settings/options of whether their communications should be analyzed and/or whether challenge response tests should be performed by a server, such as server 108 (FIG. 1).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of detecting spam communications sent from a sender device to a client device, the method comprising:
receiving at the client device, a communication initiated at the sender device;
determining at the client device whether the communication should be challenged;
storing the communication in a holding queue at the client device;
transmitting a challenge from the client device to the sender device;
receiving at the client device a response to the challenge indicative of whether the incoming communication from the sender device is from a safe sender;
analyzing the response to determine whether the incoming communication is from a safe sender; and
releasing the communication from the holding queue.

2. The method according to claim 1, wherein the communication is a short message service (SMS) message.

3. The method according to claim 2, wherein the challenge is a SMS message containing a phone number.

4. The method according to claim 3, wherein the phone number connects to a service providing an audio challenge-response test.

5. The method according to claim 4, wherein the service is resident on the client device.

6. The method according to claim 1, wherein the communication is a multimedia messaging service (MMS) message.

7. The method according to claim 6, wherein the challenge is a MMS message containing an image challenge-response test.

8. The method according to claim 7, further comprising determining at the client device whether the response to the image challenge-response test is correct.

9. A method of detecting spam telephone calls initiated from a caller device to a client device, the method comprising:
receiving at the client device a telephone call from the caller device;
determining at the client device whether the telephone call should be challenged;
automatically answering the telephone call at the client device;
prompting a user of the caller device to touch-tone a code into the caller device;
determining at the client device whether a response matches the code; and
connecting the telephone call.

10. The method according to claim 9, further comprising adding the caller device to a list of allowed devices.

11. The method according to claim 9, wherein determining at the client device whether the telephone call should be challenged further comprises determining whether the caller device is associated with a contact in an address book in the client device.

12. The method according to claim 9, wherein determining at the client device whether the telephone call should be challenged further comprises determining whether the caller device is associated with an entry in a whitelist in the client device.

13. A non-transitory computer-readable storage medium storing instructions that, when executed by a processor, cause a computer system to detect spam communications from a sender device to a receiver device, by performing the steps of:
receiving at the client device, a communication initiated at the sender device;
determining at the client device whether the communication should be challenged;
storing the communication in a holding queue at the client device;
transmitting a challenge from the client device to the sender device;
receiving at the client device a response to the challenge indicative of whether the incoming communication from the sender device is from a safe sender;
analyzing the response to determine whether the incoming communication is from a safe sender; and
releasing the communication from the holding queue.

14. The non-transitory computer-readable storage medium according to claim 13, wherein the communication is a short message service (SMS) message.

15. The non-transitory computer-readable storage medium according to claim 14, wherein the challenge is a SMS message containing a phone number.

16. The non-transitory computer-readable storage medium according to claim 15, wherein the phone number connects to a service providing an audio challenge-response test.

17. The non-transitory computer-readable storage medium according to claim 16, wherein the service is resident on the client device.

18. The non-transitory computer-readable storage medium according to claim 13, wherein the communication is a multimedia messaging service (MMS) message.

19. The non-transitory computer-readable storage medium according to claim 18, wherein the challenge is a MMS message containing an image challenge-response test.

20. The non-transitory computer-readable storage medium according to claim 19, further comprising determining at the client device whether the response to the image challenge-response test is correct.
